(19) United States
(12) Patent Application Publication
(10) Pub. No.: US 2017/0096854 A1
(43) Pub. Date: Apr. 6, 2017

(54) RETRACTABLE SHADE SYSTEM AND RELATED METHOD OF MANUFACTURING

(71) Applicant: Martin LICHTMAN, Sloatsburg, NY (US)

(72) Inventor: Martin LICHTMAN, Sloatsburg, NY (US)

(21) Appl. No.: 15/234,460

(22) Filed: Aug. 11, 2016

Related U.S. Application Data
(60) Provisional application No. 62/203,848, filed on Aug. 11, 2015.

(51) Int. Cl. E06B 9/42; E06B 9/56; E04F 10/06; E06B 9/68; E06B 9/80; E06B 9/66; E06B 9/58

(52) U.S. Cl. CPC E06B 9/42; E06B 9/66; E06B 9/56; E06B 9/58; E06B 9/68; E06B 9/80; E04F 10/0607; E04F 10/0644

(57) ABSTRACT

In one aspect, the present invention relates to a retractable shade system. In one example implementation, the system includes a shade comprised of a body of rollable material. The system also includes one or more retraction systems configured to selectively retract the shade from an unrolled state to a rolled-up state. The retraction systems include springs, a motorized retraction device, and/or a manual retraction device.

### CROSS-REFERENCE TO RELATED APPLICATION

This application claims priority to, and benefit under 35 U.S.C. §119(e) of, U.S. Provisional Patent Application No. 62/203,848, filed Aug. 11, 2015, which is hereby incorporated by reference herein in its entirety as if fully set forth below.

### BACKGROUND

The present invention generally relates to retractable shades used in the context of awnings, doors, partitions, and windows, among other areas. Conventional awnings may be constructed with a fabric that is unrolled across supporting rafters and tied down at the edges. Conventional window and door shades may use roller mechanisms fixed at a wall or ceiling-mounted rod for retraction operations. These existing approaches may not provide adequate support and tension across the fabric and thus a shade may be flimsy. In addition, in conventional awnings, due to the weight of the amount of fabric necessary for large scale implementations, excessive levels of manual force may be required to retract the shade. It is with respect to these and other considerations that the various example implementations described below are presented.

### SUMMARY

Aspects of the present invention relate to retractable shade systems and related methods of manufacturing. As used herein, a “shade” may generally refer to one or more sheets of a body of material that can be rolled and unrolled. In one example implementation, a shade includes a pocket containing one or more springs, for example constant force, steel spring strips that extend along the projection (length) of the shade that are arranged such that the bottom end of the shade that is farthest from an opposite mounted end automatically retracts by rolling back up due to the spring force causing the shade to curl back towards the mounted end. The springs can be constant force springs, steel spring strips, or similar. The pocket can be welded, sewn, or glued to the fabric of the body of the shade, or the shade can be originally manufactured with pockets in which the springs are inserted. The springs may also be directly adhered to the fabric of the body of the shade either by sewing, heat sealing, fusing or using glue, hardware, or similar materials.

The fabric can be rolled up on a roller tube or in a tubing fabric dispenser and can be pulled off the roll by either pulling on the dispenser or using a rope, cables, or cords, etc. connected to the inner end of the roll when fabric is rolled onto the roller tube. It should be noted that that the roller tube can be arranged on bearings on either end. The fabric can also be rolled up or pulled out by pulling or pushing on the outer edges of the fabric manually. The sides can be driven on tracks, guided onto rods, carried by tension clips, and/or pulled or pushed by tension springs. Among other applications, embodiments of the present invention may be used for awnings, partitions, window shades, insect screens, heat and UV protection, wind breakers, door openings, privacy shades, noise-proofing, skylights, pool covers, vehicle tarps, curtains, shower or bath enclosures, tents, posters, interior or exterior vehicle shades, boat covers, barn curtains, and/or greenhouse shades.

The fabric materials used can be coated, laminated, synthetic or natural, metallic (e.g., aluminum or stainless steel), mesh, solid, clear (e.g., clear vinyl), insulated, sound-proof, printed, and/or blank. The fabric can be held down by tying it down, or it can be held in place by fasteners at the opposite sides. The force provided by the springs in aiding the shade to retract allows for the shade, which may be large in dimension and heavy, to effectively be retracted with less manual force required or self-rollup depending on the configuration and, for awning applications, less supporting rafters may be required. For example, whereas a 30-foot awning without the spring configurations may require 100 pounds of force to roll up, the spring configurations may allow the awning to be rolled up using only 30 pounds of force. Further advantages include usability in large areas, sturdy construction, and an ability to be installed vertically, horizontally, sideways, bottom-up, or on a slant, with or without a roller tube. It should be noted that although implementations of a retractable shade described herein may be used for protection from sun, awnings with which the retractable shade may be used can be constructed to withstand environmental elements including wind and rain.

One example implementation can use a stationary frame and the fabric rolls up via a pulley and rope (or cable, cord, string, etc.) system. The fabric can be attached to a wall, ceiling, or roof by a head rod or similar component in a top pocket and the roller tube is arranged in the bottom pocket, among other possible means. Pockets are welded, glued, or sewn onto the top-sheet perpendicularly, where springs are inserted. In operation, the fabric can be pulled down by a center rope at the roller tube side and rolls up by the spring force or by pulling the rope, or a combination of both.

In one example implementation, a roller tube is mounted on a bearing or similar component next to a wall, ceiling, or roof, and the fabric is rolled on the roller tube. Pockets on either end of the fabric are welded onto a top-sheet in which springs are inserted, as well as in additional locations if needed. Optionally, there may be additional pockets on the outer edges which accommodate side rods configured such that as the shade unrolls, the pockets advance onto the rods to keep the fabric taut. The fabric can wind onto the roller either by the springs or by a motor, and the fabric can be pulled out manually, for example using a rope, cable, cord, or string, or by motor and/or using a clutch system. In some example implementations, the fabric may be deployed and retracted using an electric or gas powered motor that can produce a rotation of a winding type or rolling mechanism, such as a winch-type arrangement, or motor-driven roller type arrangement. The motor may be used in conjunction with a pulley and/or rope type system.

According to some example implementations, a shade retraction system can be manufactured by a process which uses magnetic elements in a channel and pieces of steel to eliminate air bubbles or pocket distortion during welding.

In one aspect, the present invention relates to a retractable shade system which, in one example implementation, includes a shade comprised of a body of rollable material, and one or more retraction systems. The body of rollable material can comprise a mesh material and/or a transparent material. The retraction systems are configured to selectively retract the shade from an unrolled state to a rolled-up state, and comprise springs, a motorized retraction device, and/or a manual retraction device.

The system can, in some example implementations, further include one or more pockets defined in one or more sheets of the body of material. The one or more retraction systems can include one or more springs inserted within the one or more pockets that are oriented substantially along the direction of projection of the shade when unrolled. The springs can be configured to provide a retraction force to retract the shade from an unrolled state to a rolled-up state. The springs can include one or more constant force springs and/or spring strips. In example implementations using spring strips, the spring strips can be substantially coiled when the shade is in the rolled-up state and substantially flat when the shade is in the unrolled state.

In some example implementations, the system can also include a roller tube or dispenser configured to hold the shade in the rolled-up state. The one or more pockets can include pockets defined in the one or more sheets, where the pockets are separated from one another across the width of the shade and each have one or more springs inserted therein. Each of these inserted springs can be oriented to run substantially along the length of the shade within a respective pocket. The pockets can be welded, glued, or sewn onto a top sheet of the one or more sheets.

The system can, in some example implementations, also include side rods oriented in a direction substantially parallel to the projection direction of the shade when unrolled. The pockets can include side edge pockets defined in one or more sheets of the body of material, proximate the side edges thereof and oriented substantially along the length of the one or more sheets. Each of the side edge pockets can be configured to advance on and along the respective side rods as the shade moves from the rolled-up state to the unrolled state. In some example implementations, the system may also include a dispenser configured to hold the shade when in the rolled-up state and to selectively dispense the shade from the rolled-up state to the unrolled state. The dispenser may be configured to mount to a top or side section of a door or window frame.

The shade can include one or more magnetic elements or mechanical fasteners proximate an end thereof and configured to couple the corresponding end of the shade to an opposing, opposite side section of a door or window frame from the side section at which the dispenser is mounted, when the shade is in the unrolled state. The one or more magnetic elements can be configured to magnetically couple to corresponding magnets or metal at the opposite side section of the door or window frame when the shade is in the unrolled state.

The system can, in some example implementations, include side rails configured to guide the shade at the side edges thereof as the shade moves between a rolled-up state and unrolled state. The side rails can be configured to selectively fix the position of the shade at a selected location along the side rails, including a location at which the shade is not in a fully unrolled state. In some example implementations, the system may include a magnetic element configured to selectively, magnetically fix the position of the shade at a selected location along the side rails, including a location at which the shade is not in a fully unrolled state.

In another aspect, the present invention relates to a retractable shade system which, in one example implementation, includes a shade comprised of a body of rollable material, a plurality of side rails, and a plurality of fasteners. Each of the fasteners can be configured to selectively engage the shade at a side edge thereof and to move along a respective one of the side rails. The fasteners may comprise clips configured to engage the shade by clamping down on the shade, and one or more of the fasteners may have a rolling portion.

In some example implementations, one or more of the side rails can include a section that is configured to laterally shift the position of a fastener engaging the shade as the fastener advances in a direction substantially along the length of the side rail and to thereby cause an increased tension across the shade such that the shade is kept taut across the width thereof. The section of at least one of the side rails that is configured to laterally shift the position of a fastener can comprise an angled portion configured to produce the lateral shift of the fastener, and/or can comprise set screws configured to selectively increase or decrease lateral pull on the fastener.

One or more of the side rails can include a section configured to impose an increased closing force on a fastener as the fastener advances in a direction substantially along the length of the side rail, to thereby increase force of the engagement of the fastener on the shade. The section of at least one of the side rails that imposes the increased closing force can include a portion configured to impose a vertical force on one or both of the top and bottom of the fastener to increase force of the engagement of the fastener on the shade.

In some example implementations, the section of at least one of the side rails that imposes the increased closing force comprises one or more set screws configured to selectively increase the force of the engagement of the fastener on the shade. The portion configured to impose the vertical force can include an elevating section configured to increase the vertical elevation of the fastener from one or both of the top and bottom. The system may also include a top panel such that the elevating section is configured to increase the vertical elevation of the fastener and push the fastener against the top panel as the fastener advances in a direction substantially along the length of the side rail. Increasing the vertical elevation can cause the top and/or bottom of the fastener to squeeze and thereby increase the force of the engagement.

In another aspect, the present invention relates to a method of manufacturing a retractable shade. In one example implementation, the method includes defining one or more pockets in a shade comprised of one or more sheets of a body of rollable material. The pockets are configured to receive one or more springs for providing a retraction force to retract the shade from an unrolled state to a rolled-up state. The method also includes disposing one or more magnetic elements between vacuum elements located on either side of one or more sheets, where the one or more magnetic elements are configured to hold the one or more sheets of material such as to prevent entry of air into the one or more pockets while the shade is being formed.

The one or more magnetic elements can be configured to hold down the one or more sheets during welding for defining the one or more pockets. In some example implementations, the one or more magnetic elements comprise a magnetic strip disposed in a channel defined between the vacuum elements. In some example implementations, the one or more magnetic elements comprise at least one magnet disposed between the vacuum elements and below the one or more sheets configured to, in combination with at least one other magnets disposed on top of the one or more sheets, create a magnetic force that holds the one more sheets and prevents the entry of air into the one or more pockets.

In some example implementations, the one or more magnetic elements comprise at least one magnet above or below the one or more sheets, and the method further comprises disposing a metal element on a top or bottom side of the or more sheets that is opposite the at least one magnet. Disposing the one or more magnetic elements between the vacuum elements can comprise placing at least one magnetic element of the one or more magnetic elements on top of the one or more sheets of material and at least one other magnetic element of the one or more magnetic elements below the one or more sheets of material to generate a magnetic force pressing on the one or more sheets of material to prevent entry of air into the one or more pockets while the shade is being formed.

### BRIEF DESCRIPTION OF THE DRAWINGS

Other aspects and features of example implementations of the present invention will become apparent to those of ordinary skill in the art, upon reviewing the following detailed description in conjunction with the accompanying figures.

FIGS. 1A-1C show a retractable shade system used for an awning, in accordance with one example implementation of the present invention. Specifically, FIG. 1A shows the frame of the awning, FIG. 1B shows a top-sheet of the shade in an unrolled position, and FIG. 1C shows the shade of the awning in a substantially rolled-up position.

FIGS. 2A and 2B show a retractable shade system according to one example implementation of the present invention.

FIGS. 3A and 3B show springs in welded pockets of a retractable shade system in accordance with example implementations of the present invention, wherein FIG. 3A shows a spring inserted in a welded pocket in the center of the fabric and FIG. 3B specifically shows a spring inserted on the sides of the fabric.

FIGS. 4A and 4B show a retractable shade system utilized in a window frame, in accordance with one example implementation of the present invention.

FIGS. 5A-D show a side rail configuration and fasteners for a retractable shade system in accordance with one example implementation of the present invention, and FIG. 5E shows a particular configuration of a fastener with a rolling portion in accordance with one example implementation of the present invention.

FIG. 6A provides a perspective view of a retractable shade system in accordance with one example implementation of the present invention, with an unrolled shade for an awning without the use of support rafters, and FIG. 6B shows a side profile of an end of a side rail shown in FIG. 6A.

FIGS. 7A and 7B show aspects of a process of manufacturing a retractable shade in accordance with one example implementation of the present invention.

### DETAILED DESCRIPTION

Although example implementations of the present invention are explained in detail, it is to be understood that other implementations are contemplated. Accordingly, it is not intended that the present invention be limited in its scope to the details of construction and arrangement of components set forth in the following description or illustrated in the drawings. The present invention is capable of other implementations and of being practiced or carried out in various ways.

It must also be noted that, as used in the specification and the appended claims, the singular forms “a,” “an” and “the” include plural referents unless the context clearly dictates otherwise.

In describing example implementations, terminology will be resorted to for the sake of clarity. It is intended that each term contemplates its broadest meaning as understood by those skilled in the art and includes all technical equivalents that operate in a similar manner to accomplish a similar purpose.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more operations according to a method does not preclude the presence of additional operations or intervening operations between those expressly identified. Operations of a method may be performed in a different order than those described herein. Similarly, it is also to be understood that the mention of one or more components in a device or system does not preclude the presence of additional components or intervening components between those components expressly identified.

In the following detailed description, references are made to the accompanying drawings that form a part hereof and that show, by way of illustration, specific implementations or examples. In referring to the drawings, like numerals represent like elements throughout the several figures.

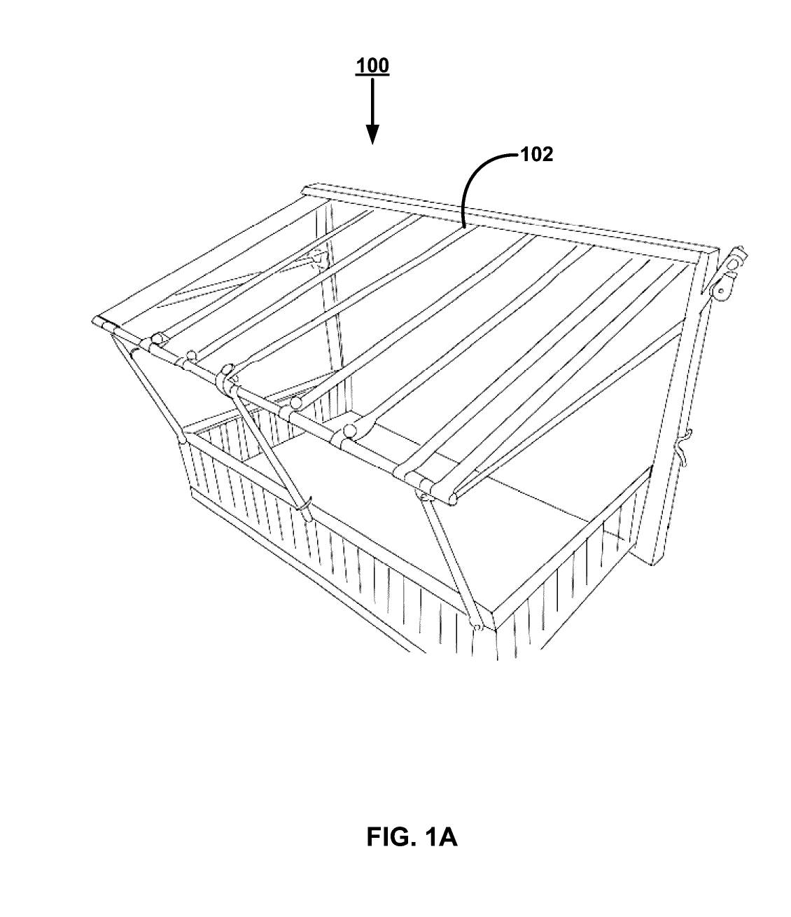

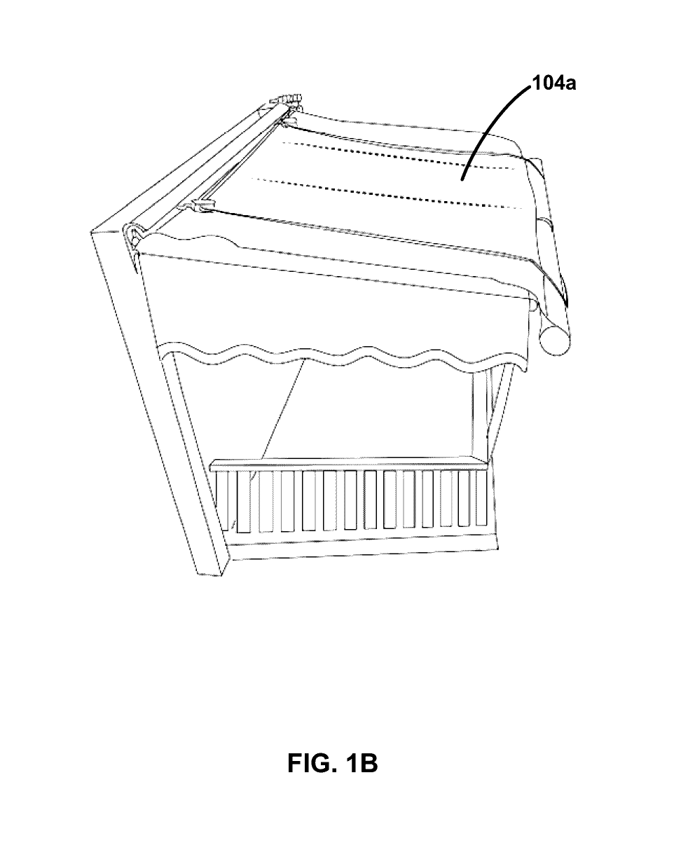

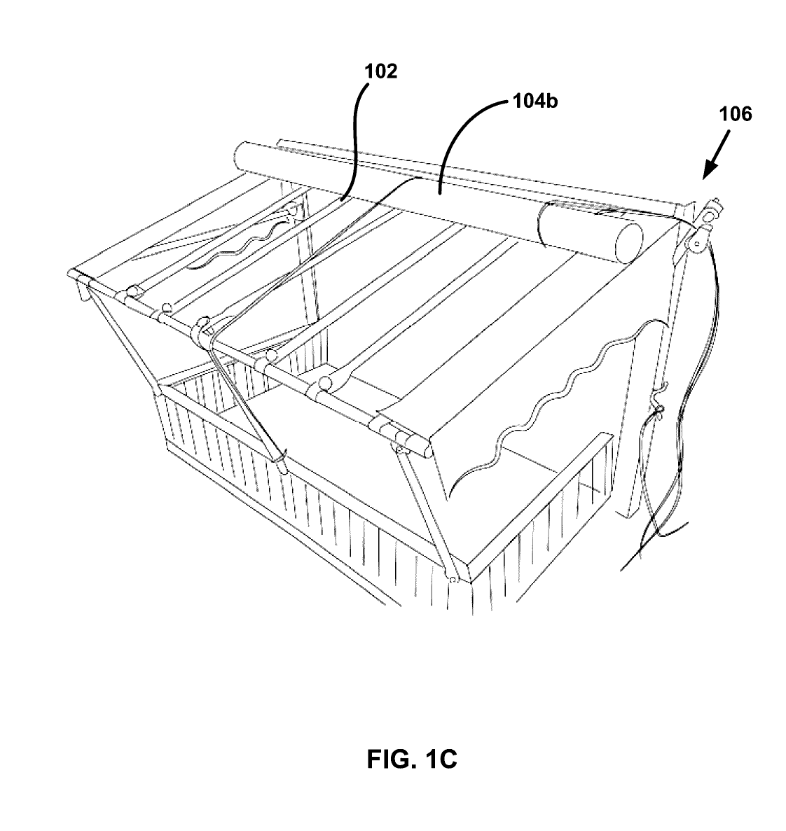

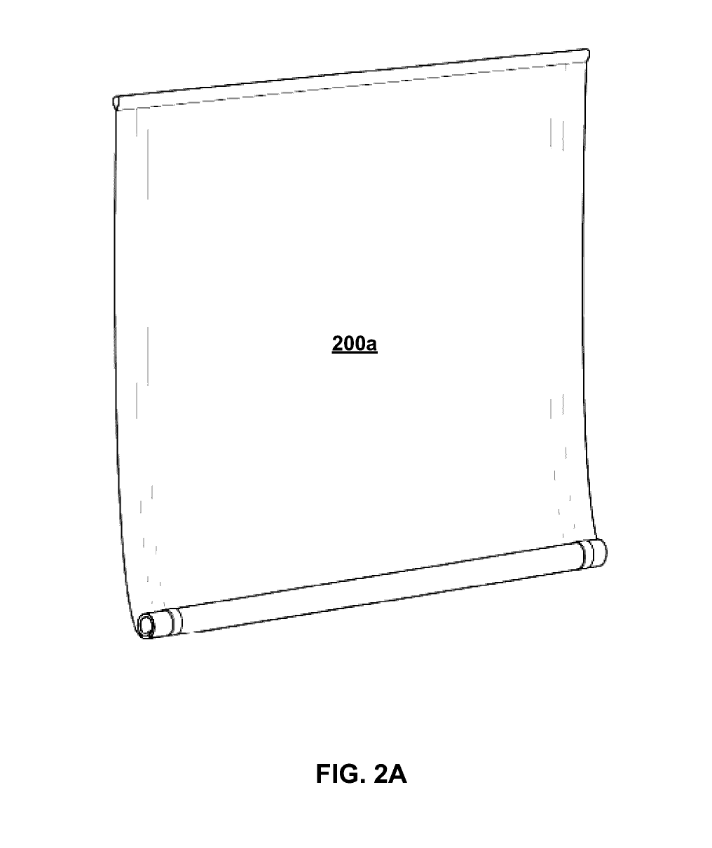

FIGS. 1A-1C show a retractable shade system used for an awning, in accordance with one example implementation of the present invention. A top-sheet is arranged over support structures 102 oriented in parallel along the projection of the frame of the awning (see FIG. 1A in particular, illustrating the frame 100 of the awning), where the support structures 102 (e.g., rafters) span from a first end of the awning frame 100 to a second, opposite end. The shade may be deployed by unrolling the fabric of the shade along the projection using a pulley and rope system 106 (see FIG. 1C). FIG. 1B shows the shade 104 on the awning in an unrolled position (see 104a), and FIG. 1C shows the shade 104 on the awning in a substantially rolled-up position (see 104b).

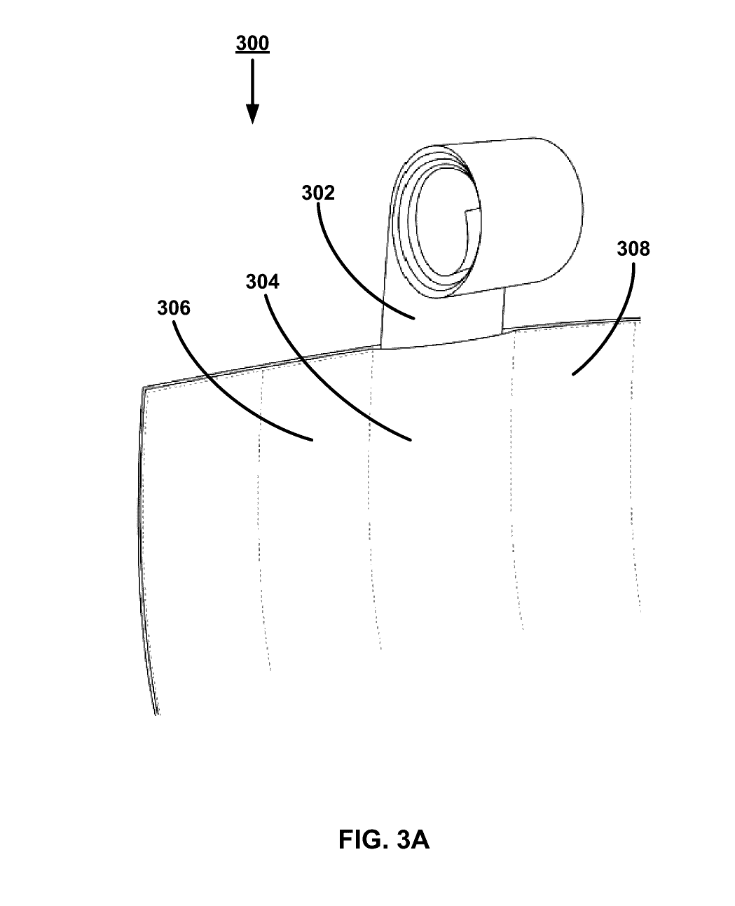

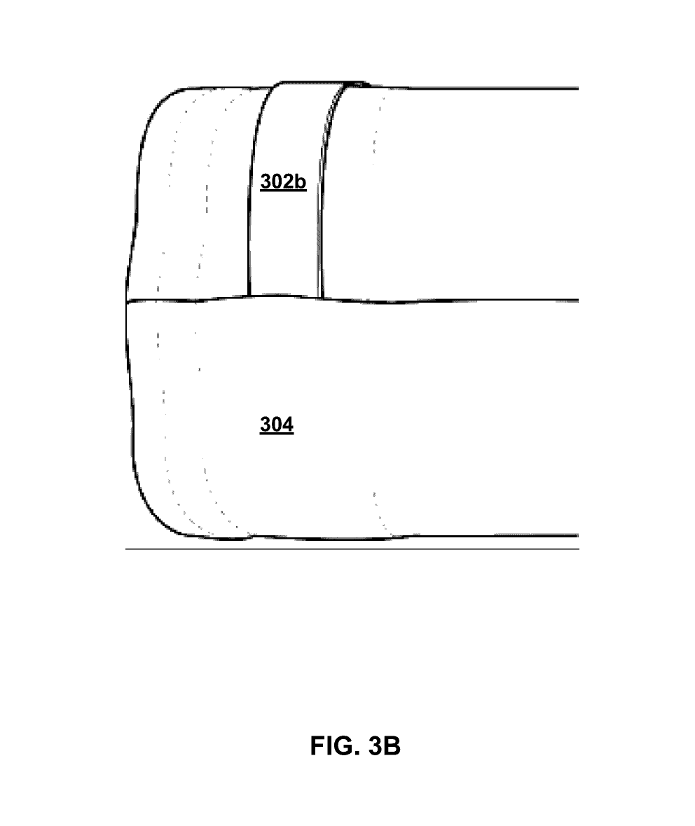

Various retraction systems may be utilized for the unrolling and rolling-up (retraction) of the shade. In some example implementations, the shade retracts back to the rolled-up position by the force of springs that are arranged as spring strips inserted within pockets along the fabric of the shade in the direction of the projection (see further details in FIGS. 3A and 3B). In certain example implementations, the shade may be unrolled and/or retracted back to a rolled-up or partially unrolled position using, along with or alternatively to the springs, manual retraction devices using rope, cable, or string and/or through the use of motorized retraction devices such as a motorized winding system.

In example implementations that use springs for the retraction, the springs can generally be spring strips that have an original shape of a coil, but when unwound they extend outwards and in a linear direction to be substantially flat. The springs may be constructed of stainless steel such as type 301 stainless steel. The retraction force acting to roll up the shade is due to the springs returning to their original shape.

As shown in FIGS. 3A and 3B, springs 302 are inserted in pockets of the fabric 304, 306, 308 and may be spaced apart laterally by a preset distance depending on the required or desired force needed to roll up the shade. For instance, for an awning that is 30 feet in width with a projection of 15 feet, a pocket with springs may be placed every 2-4 feet across the width of the shade. Multiple springs such as spring strips can be connected end to end along the length of a pocket for shades having a long projection distance. For instance, multiple spring strips may be welded, glued, or otherwise coupled to one another along the length of the projection of the shade within a respective pocket. The shade retracts by the force of the springs such that the fabric may roll up towards the base end of the frame. In addition, the shade may be configured such that the springs provide assistance for rolling up the awning by alleviating much of the weight of the awning to make it effectively lighter. The size, strength, and/or materials of the springs may vary according to the dimensions of an awning for which the shade may be utilized.

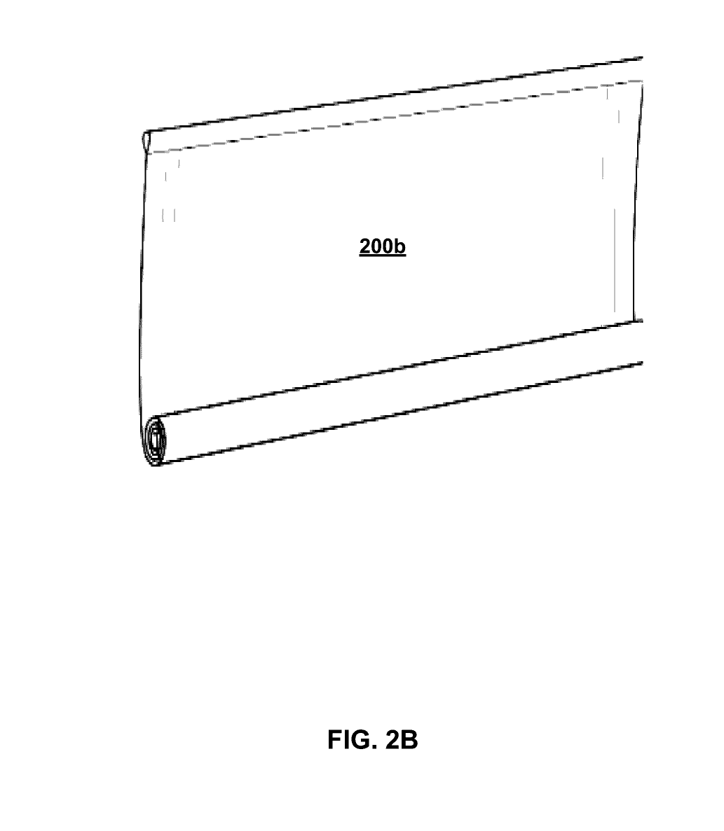

FIGS. 2A and 2B show a window shade configuration according to one example implementation of the invention, in which the shade 200 may be rolled out into a position to cover, for instance, a window or door (e.g., residential front, back, side door or garage door) by exerting a force against the retracting force of the retraction system (e.g., through springs inserted within pockets of the fabric of the shade, or by pulling on the shade using a manual device such as a rope or string and/or motorized device). The shade may be arranged within a frame of a door or window, for example. In one example implementation, the fabric of the shade is initially rolled up at a base mounted to a wall structure or portion of a door or window frame, and then is deployed by rolling down the shade along the length of the frame. The shade can be made with fasteners such as Velcro® fasteners on the edges such that the shade adheres to the window when it is rolled down. As shown by the progression from FIG. 2A to 2B (where 2A shows the shade 200a in an unrolled position and 2B shows the shade 200b in a partially unrolled position as it is retracting), the shade retracts by curling up and back to its initial rolled-up position, which, in example implementations that utilize springs for retraction, is due to the spring force of springs inserted in pockets in the fabric of the shade (see FIGS. 3A and 3B for further detail).

FIGS. 3A and 3B show springs and pockets (collectively 300) of a retractable shade system in accordance with one example implementation of the present invention, where FIG. 3A shows a spring strip 302a inserted in a welded pocket 302 in the center of the fabric and FIG. 3B specifically shows a spring strip 302b inserted on the sides of the fabric. Specifically, in FIG. 3A, 306 corresponds to a first side of the pocket weld and 308 corresponds to the second side of the pocket weld. The pocket is labeled as 304 and the spring is labeled 302a. As shown in FIG. 3A, the spring strip 302a (see top portion extending out of pocket) has a natural shape that is substantially coiled. The arrangements shown in FIGS. 3A and 3B can be used in whole or in part with the awning and/or window shade implementations illustrated in FIGS. 1, 2, 4, 5, and/or 6.

As further examples of applications for a retractable shade system in accordance with example implementations of the present invention, the retractable shade system may be used for partitions, windows, doors, or skylights. A partition may be mounted from above on a ceiling or roof, with the fabric rolling vertically. The fabric of the partitions can be composed of sound-proofing materials or insulating materials, which may include screening, mesh or regular fabric, and may be uncoated or laminated, printed, or blank. The partition may serve to separate spaces of an indoor space, for instance as a separation curtain to divide areas of an industrial space or gymnasium. The partition may additionally or alternatively serve as an insect screen or privacy curtain. As one example, a privacy curtain implementation of the partition may be configured for use with an indoor or outdoor pool. Other applications include screens and/or storm protection covers that may be used in the areas of doors, windows, or skylights, among others.

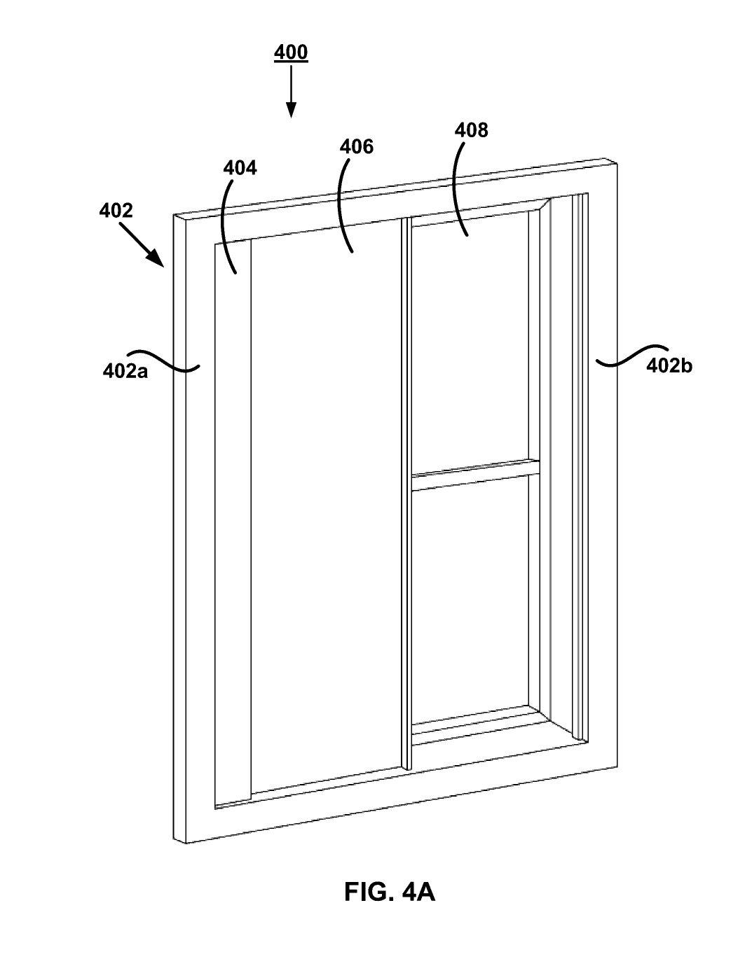

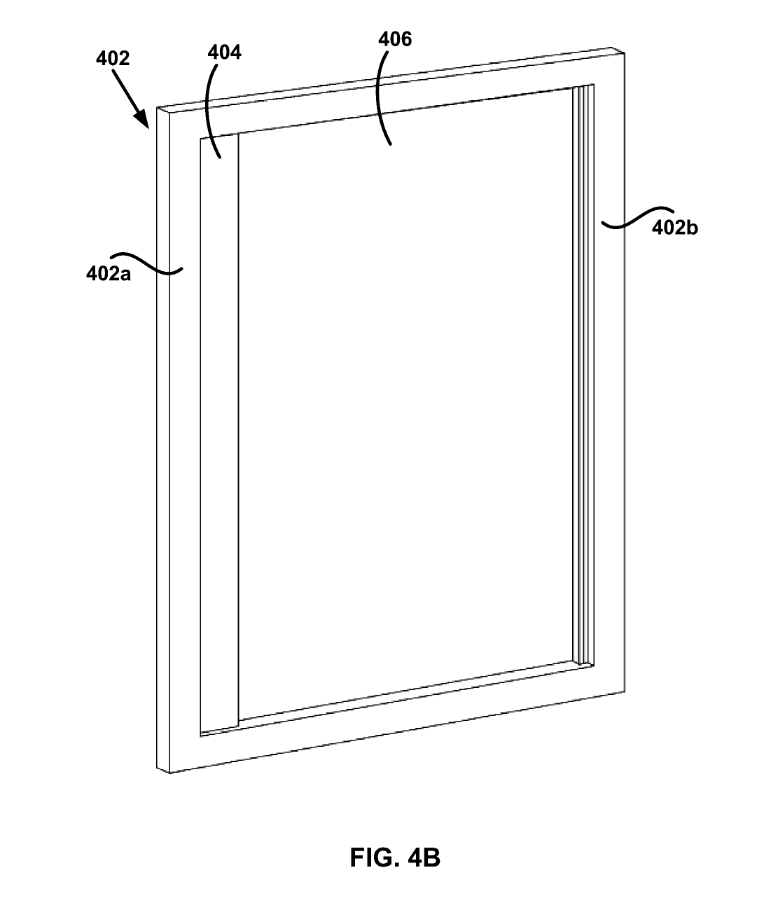

FIGS. 4A and 4B show a retractable shade system 400 utilized in a window frame 402, in accordance with one example implementation of the present invention. As shown, a dispenser 404 (which may also be referred to herein as a cassette, or other type of enclosure for containing rolled up fabric and allowing the fabric to be selectively dispensed therefrom) is placed in a sideways orientation with respect to the window frame 402 such that, when pulled out, the shade 406 unrolls out of the dispenser 404 from one side of the frame 402a to span across to the other side of the frame 402b and cover the window 408.

Other implementations can use multiple dispensers, either stacked side-by-side on the same side of the frame or with one dispenser on one side of the frame and one dispenser on the opposite side of the frame. In such a multiple-dispenser arrangement, one dispenser may provide a shade configured to serve as screen while the other dispenser may provide a shade configured to serve as a clear protective layer (e.g., storm door type function). The dispenser(s) may be secured on (e.g., mounted to) an interior or exterior portion of the frame or wall (e.g., an interior portion or exterior portion of a door frame or window frame). As another example, the retractable shades may be configured to serve as vertically retractable walls that can close off the sides of an area that is covered overhead (e.g., overhanging roof) but open on the sides. In yet another example, the retractable shades may serve as walls for awnings, in which the shades may be configured to be sideways or vertically retractable to form one or more enclosures for the awning.

In some example implementations, magnetic elements may be placed at an end of the shade that interfaces with the opposite side of the frame (i.e., across from a side with the dispenser), for instance at a door jamb. The magnetic elements can engage with metal or other magnets placed on this opposite side of the frame to secure the shade while also permitting the shade to be selectively retracted and rolled back up into the dispenser as desired. In other example implementations, a mechanical lever configured may be used which may retract a steel pin at top and bottom, where a slotted track may hold the end in position, for purposes of securing and selective retraction of the shade.

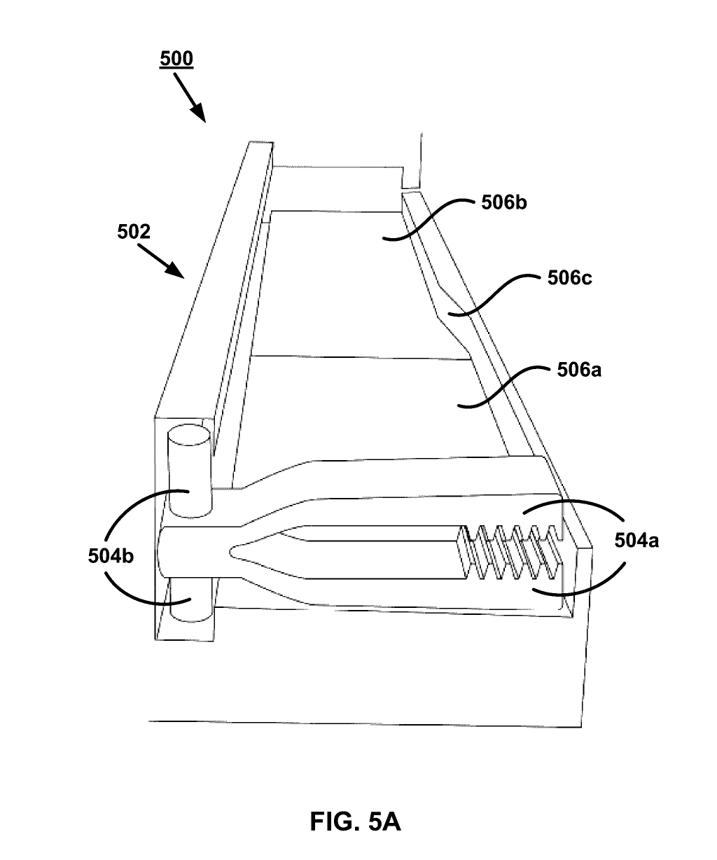

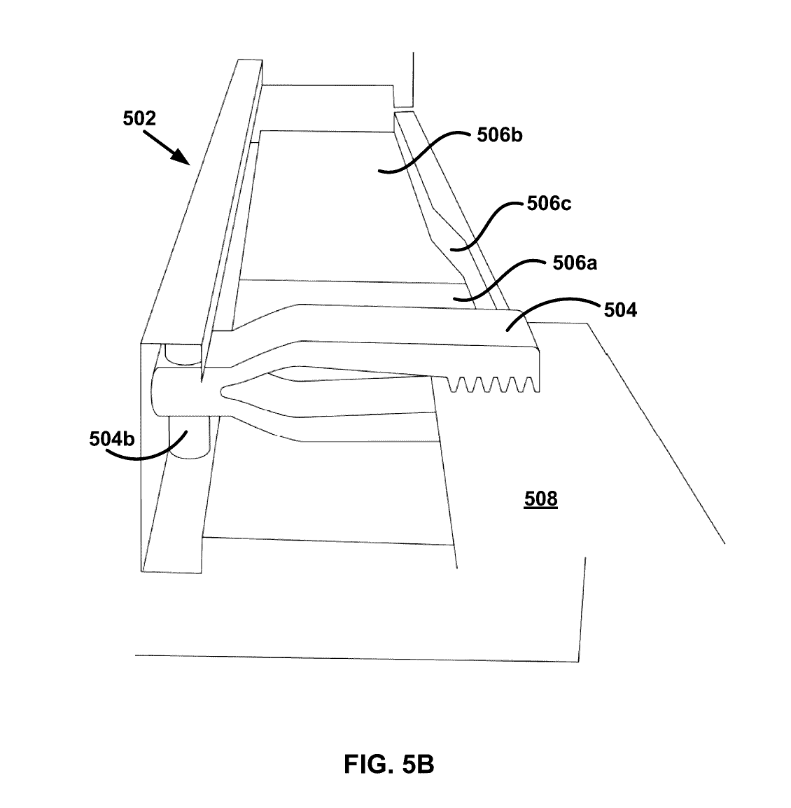

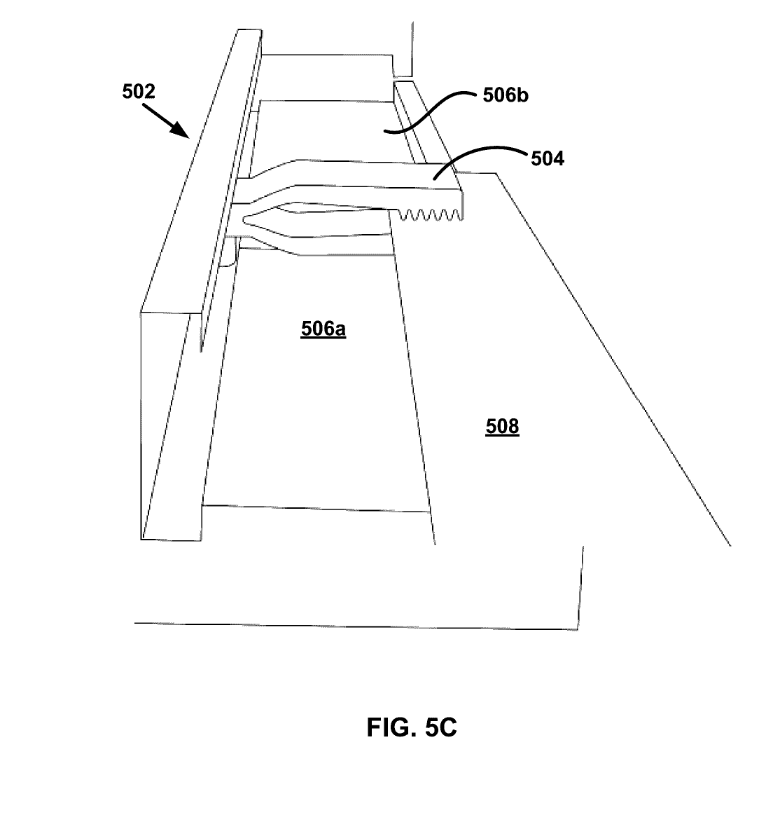

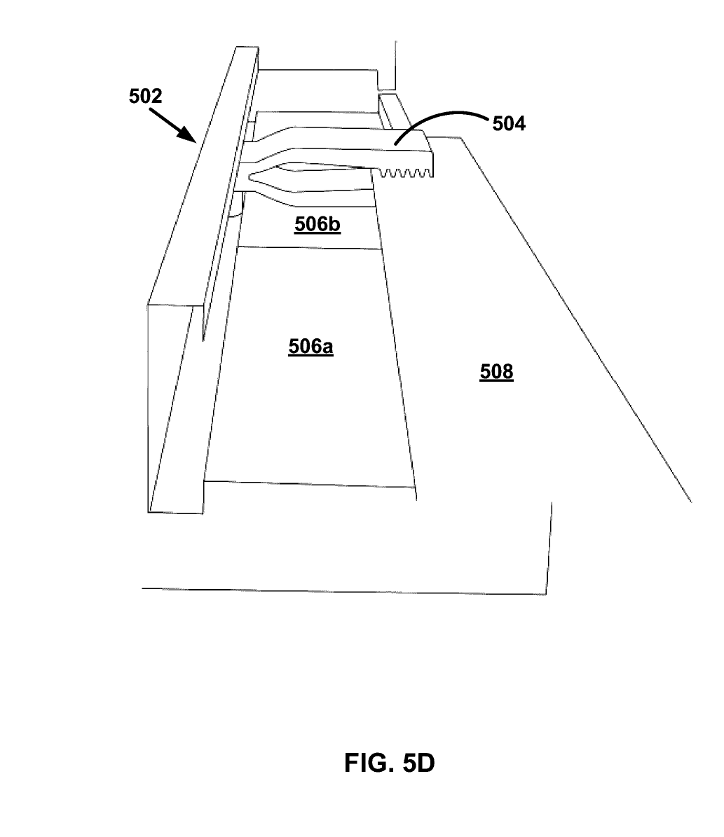

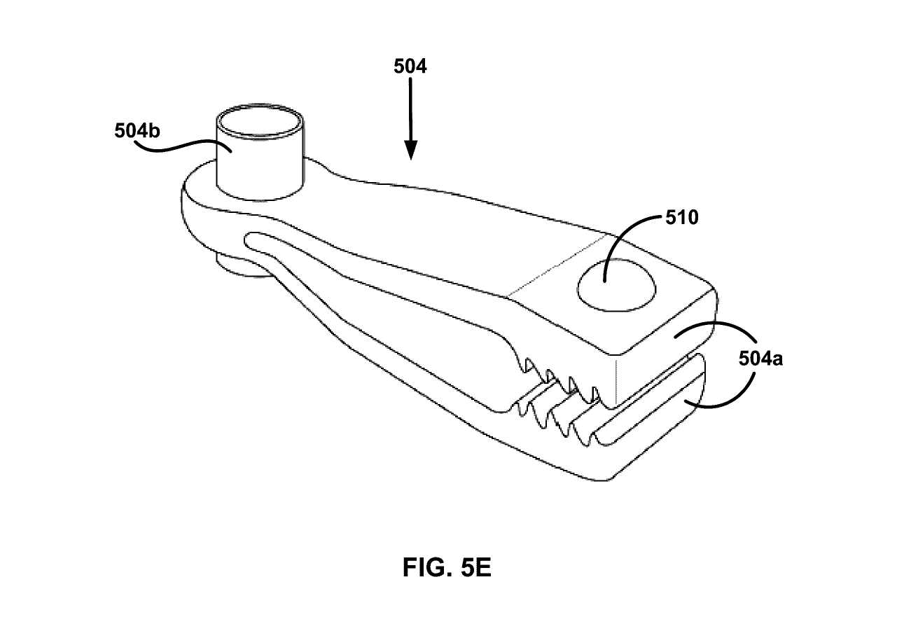

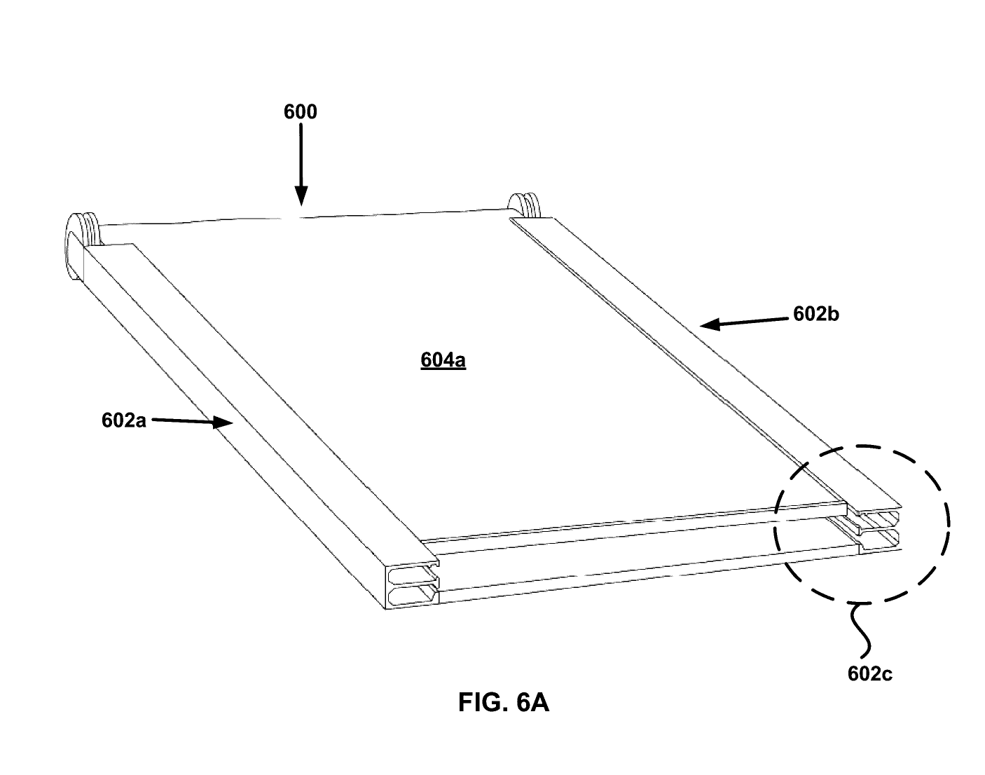

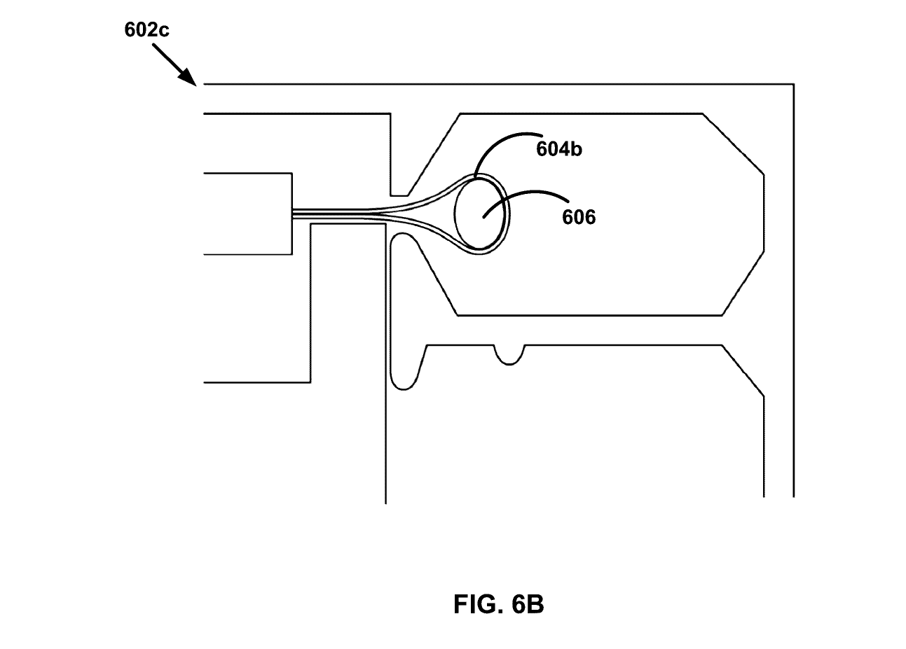

The shade may be composed of a mesh material to serve as an insect screen, or it may be composed of a clear material (e.g., clear vinyl) to serve as a storm protection-type shielding layer, shower door, or skylight. For UV radiation and heat protection, a heavy mesh may be used. Side rail configurations will be discussed more below with reference to FIGS. 5A-5D, 6A, and 6B, but as a mention of further aspects of some example implementations of the present invention for door, window, or skylight settings, among others, a vertical extrusion pulling the fabric of the shade out of the dispenser can lock magnetically to a top and bottom rail of the retractable shade system such that the shade may be stopped at any location along the unrolling progression, including locations at which point the shade has not been fully unrolled.

FIGS. 5A-D show a side rail with a clip configuration (collectively 500) for keeping the fabric of a shade taut when used in settings such as awnings, pool covers, sun shades, or doors, in accordance with one example implementation of the present invention. It should be noted that one or more “clips” as discussed in relation to the example implementations shown in FIGS. 5 and 6 may be generally referred to herein as a type of fastener. It should be appreciated that the fasteners described herein are not limited to the clip configurations shown in these figures, and likewise the clip configurations are not limited to the particular shape and gripping means, etc. of those clips shown, but rather may take the form of other various types of suitable clamping means or other mechanical mechanism that can grip or otherwise engage fabric of the shade. The side rail 502 can be located on both sides of the fabric of a shade to guide the fabric as it unrolls (see also, e.g., side rails 602a, 602b shown on left and right sides of the retractable shade system shown in FIG. 6A). As shown in FIG. 5A and by the progression from FIG. 5B to 5D, a track 506a, 506b, 506c (collectively 506) of the side rail 502 that includes an angled section 506c is configured to laterally shift the position of the clip 504 and the fabric 508 engaged by the clip 504 in a lateral direction as the clip 504 moves along the side rail 502, in order to pull the fabric 508 laterally to increase tension along the material such that the fabric 508 is kept taut across the width of the shade from one side to the other. The clip 504 engages the fabric 508 using gripping portions (which may be in the form of teeth-like means as shown or in another form of clamping-type configuration for secure engagement), on an engaging end 504a of the clip 504 that is opposite an end 504b of the clip 504 that comprises a substantially vertical portion for guiding the clip within and along the side rail 502.

One or more sections of the track 506 can include an elevating portion (which may be part of portion 506a of the track 506, for instance) that is configured to elevate the position of the clip 504 as it advances, such that as the position of the clip 504 progresses along the track 506, the clip 504 grips the fabric 508 with increased force. Although FIGS. 5A-5D show the clip 504 and fabric being pulled manually along the track 506, it should be recognized that in some example implementations such as those described herein with reference to FIGS. 1-4, the clip 504 can be pulled or pushed along the track 506 by a rope and/or rope and pulley system, motor, or tension springs, among other possible means of advancing the clip 504 along the track 506. In some example implementations, a series of clips can be connected in a chain-like formation such that the clips work in combination. The quantity and/or dimensions of the clips may vary depending on the size and weight of the shade and, in some implementations, the dimensions of an awning on which the shade may be used. The clip 504 may be constructed of metal, plastic, or other machine-able material, among other various materials.

FIG. 5B specifically shows the clip 504 at a first location of the track 506. FIG. 5C shows the clip 504 in a second location on the track 506 that is farther along compared to the first location as shown in FIG. 5B, since the clip 504 has advanced along the track 506. As shown, the clip 504 is gripping the fabric 508. FIG. 5D shows the clip 504 in a third location that is still further along the track 506. As shown in FIGS. 5C and 5D in comparison to FIGS. 5A and 5B, as the clip 504 has moved from the first location on the track 506 to the second and third locations, the position of the clip 504 has shifted laterally due to the angled section 506c. Although not shown, the side rail 502 may in some example implementations include set screws that are configured to selectively increase or decrease lateral pull on the clip 504.

The elevating section of the track 506 may ramp up to a higher flat section, which increases the elevation of the clip 504 as the clip 504 moves along the track 506. The change in elevation in effect causes top and/or bottom portions of the engaging end 504a of the clip 504 to close together with increased force such that they clamp down to firmly grip the fabric 508. In some example implementations, when the clip is elevated due to the elevating section, it can be pushed up against a top panel to effectively generate the vertical pressure to close the clip and grip the fabric. FIG. 5E shows a configuration of a clip 504 having the components of the clip 504 as shown in the example implementations of FIGS. 5A-5D, but also including a rolling portion 510. The rolling portion 510 may include a ball bearing or other form of bearing, a wheel, or other form of rollable mechanism that promotes smooth movement of the clip 504 along the side rail sections such as the track section 506. Although the rolling portion 510 is shown on a top section of an end 504a of the clip 504, it should be recognized that one or more rolling portions can be placed on other sections of the clip, including bottom or side portions for further facilitating ease of movement for the clip 504.

FIG. 6A provides a perspective view of a shade system 600 with a shade 604a (shown in an unrolled state) for an awning without the use of support rafters, in accordance with one example implementation of the present invention, and FIG. 6B shows a side profile of the end 602c of the right side rail 602b shown in FIG. 6A. As illustrated in FIG. 6B, a pocket 604b on an outer edge of the shade accommodates a rod 606 within a hollow area of the side rail. The pocket 604b and rod 606 are arranged such that as the shade unrolls, the pocket 604b advances along the rod 606 to keep the fabric taut. The length of the rod 606 may be substantially the same as the length of the side rail. Although not shown in FIG. 6B, the left side rail shown 602a in FIG. 6A has substantially the same pocket and rod configuration as the right side rail 602b shown in FIG. 6B. The rafter-less example implementation of FIGS. 6A and 6B provides a retractable shade that does not require supporting rafters in order to keep tension on the fabric. Springs may be inserted in the pockets running down the length of the shade, in conjunction with tension components (including the clips, for example) at the side rails, to provide tension force that keeps the fabric taut.

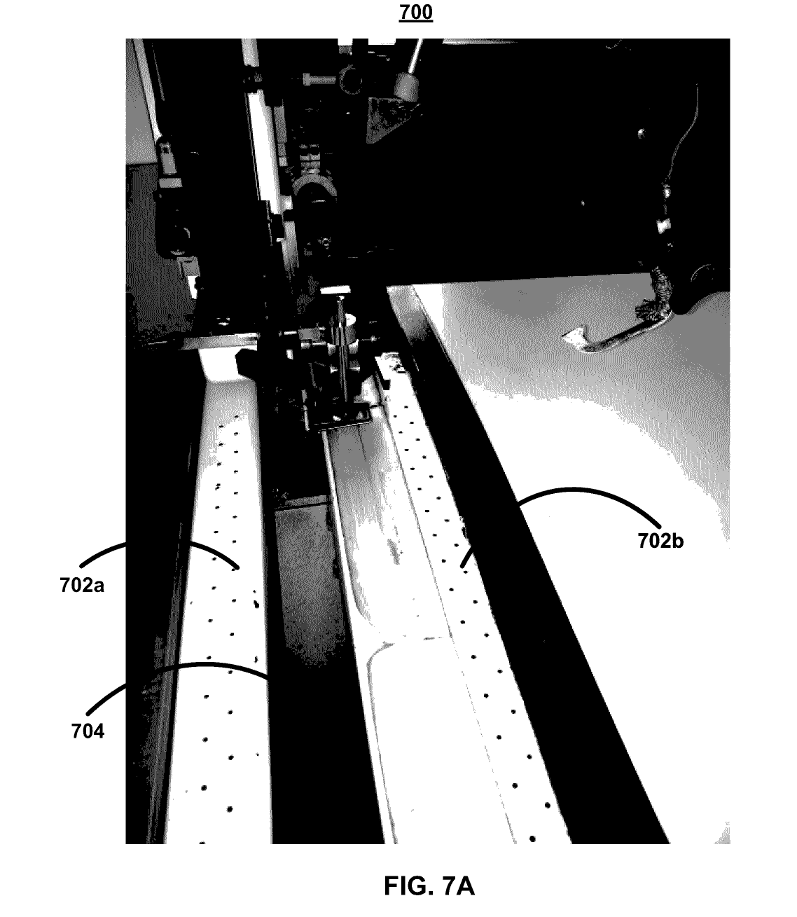

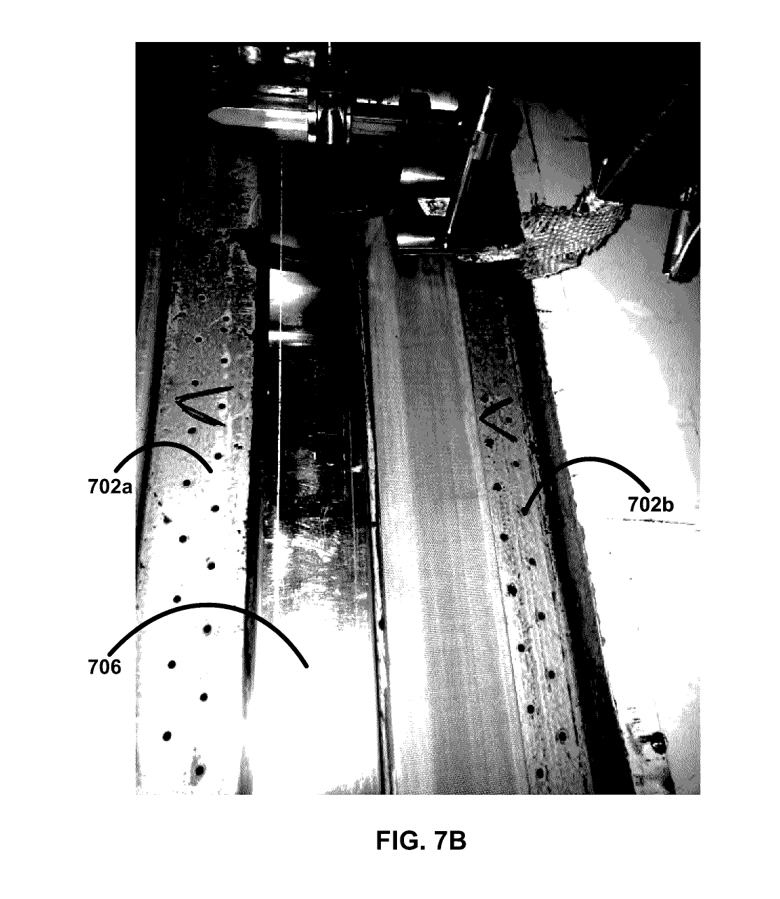

Now referring to FIGS. 7A and 7B, some example implementations of the present invention relate to a process of manufacturing a retractable shade. In one example implementation, magnetic force is used to hold down a top piece of steel on an aluminum channel, in order to eliminate air bubbles during welding of pockets in which springs are inserted for a retractable shade, for instance a retractable shade according to one or more of the example implementations. It should be noted that when welding fabric with mesh pocket configurations, this method may not be necessary.

As shown in FIGS. 7A and 7B, a system 700 has a machine using a vacuum force (see vacuum pieces 702a and 702b and vacuum holes “V”) to hold the fabric down, and there is a small space 704 between the two vacuum pieces. To aid in holding the fabric down, a magnet strip 706 (“M”) is placed within the space between the two vacuum pieces. It should be recognized that in this example implementation, the fabric may be polyvinyl chloride (PVC) based or any other weld-able fabric with our without the use of sealing adhesive tape which may be placed in between pieces of the fabric. To weld the fabric, for example implementations with welded pockets, hot air is blown from a nozzle into a seam between two pieces of the fabric. A roller comes across the top to press the two pieces together to ensure a strong weld. This example implementation of the present invention overcomes an issue that occurs when hot air becomes trapped into the pocket and causes a bulge in the pocket. This issue is overcome by placing magnets in the bottom in a channel such that the magnetic fields apply on top of the metal. The piece of flat steel can be placed on top of the fabric, on top of the magnet, to prevent air from entering the pocket. As another option, RF or bar welding can be used such that both sides of the fabric can to be welded at the same time, instead of separately, to prevent air build-up. In some example implementations, the pockets may be glued or sewn rather than welded.

The following provides further details regarding the above-mentioned implementations of the process of manufacturing according to example embodiments of the present invention. In one example implementation, two pieces of fabric can be arranged one on top of the other, with an overlap seam. Heat is applied in between and then a high pressure wheel presses down to cause the fabric to weld together.

In one example implementation, in order to weld the two fabrics, a suspended heat nozzle may go in and out in between them. A magnetic strip is placed in the space between the two vacuums. For the second weld to form the pocket, a piece of steel can be placed on the fabric to close up the void, such that no air could be trapped in that void or into that pocket. As one configuration, a magnet strip may also be placed on top of the fabric, such that one magnet is placed on the bottom and one is placed on top, in order to produce a stronger magnetic force if desired; other configurations can use a magnet on top with a plain piece of steel on the bottom.

As a working example, one side of a five-inch strip of fabric of a top-sheet can be welded with a one-inch weld. The top sheet is then turned around and the second side is welded. For the weld of the second side, a piece of steel is placed on top of the fabric in order to hold it against the magnetic elements and therefore prevent air bubbles from entering the pocket.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the present invention and its equivalents as set forth in the following claims. Therefore, other modifications or implementations as may be suggested by the teachings herein are particularly reserved as they fall within the breadth and scope of the claims here appended.

What is claimed is:

1. A retractable shade system, comprising:
a shade comprised of a body of rollable material; and
one or more retraction systems configured to selectively retract the shade from an unrolled state to a rolled-up state, the retraction systems comprising at least one of springs, a motorized retraction device, and a manual retraction device.

2. The system of claim 1, further comprising one or more pockets defined in one or more sheets of the body of material, and wherein the one or more retraction systems comprise one or more springs inserted within the one or more pockets and oriented substantially along the direction of projection of the shade when unrolled, the one or more springs being configured to provide a retraction force to retract the shade from an unrolled state to a rolled-up state.

3. The system of claim 2, wherein the one or more springs comprise a constant force spring.

4. The system of claim 2, wherein the one or more springs comprise a spring strip.

5. The system of claim 4, wherein the at least one spring strip is substantially coiled when the shade is in the rolled-up state and substantially flat when the shade is in the unrolled state.

6. The system of claim 1, further comprising a roller tube or dispenser configured to hold the shade in the rolled-up state.

7. The system of claim 2, wherein the one or more pockets comprise a plurality of pockets defined in the one or more sheets, the pockets being separated from one another across the width of the shade and each having one or more springs inserted therein, each of the one or more springs running substantially along the length of the shade within a respective pocket.

8. The system of claim 2, wherein the one or more pockets are welded, glued, or sewn onto a top sheet of the one or more sheets.

9. The system of claim 2, further comprising side rods oriented in a direction substantially parallel to the projection direction of the shade when unrolled, wherein the one or more pockets comprise side edge pockets defined in one or more sheets of the body of material, proximate the side edges thereof and oriented substantially along the length of the one or more sheets, each of the side edge pockets configured to advance on and along the respective side rods as the shade moves from the rolled-up state to the unrolled state.

10. The system of claim 1, further comprising a dispenser configured to hold the shade when in the rolled-up state and selectively dispense the shade from the rolled-up state to the unrolled state, and configured to attach to a top or side section of a door or window frame.

11. The system of claim 10, wherein the shade further comprises one or more magnetic elements or mechanical fasteners proximate an end thereof and configured to couple the corresponding end of the shade to an opposing, opposite side section of the door or window frame from the side section at which the dispenser is mounted, when the shade is in the unrolled state.

12. The system of claim 11, wherein the one or more magnetic elements are configured to magnetically couple to corresponding magnets or metal at the opposite side section of the door or window frame when the shade is in the unrolled state.

13. The system of claim 1, further comprising side rails configured to guide the shade at the side edges thereof as the shade moves from the rolled-up state to the unrolled state.

14. The system of claim 13, wherein the side rails are configured to selectively fix the position of the shade at a selected location along the side rails, including a location at which the shade is not in a fully unrolled state.

15. The system of claim 13, further comprising a magnetic element configured to selectively, magnetically fix the position of the shade at a selected location along the side rails, including a location at which the shade is not in a fully unrolled state.

16. The system of claim 1, wherein the body of rollable material comprises a mesh material.

17. The system of claim 1, wherein the body of rollable material comprises a substantially transparent material.

18. A retractable shade system, comprising:
a shade comprised of a body of rollable material;
a plurality of side rails; and
a plurality of fasteners, each of the fasteners configured to selectively engage the shade at a side edge thereof and to move along a respective one of the side rails.

19. The system of claim 18, wherein the fasteners comprise clips configured to engage the shade by clamping down on the shade.

20. The system of claim 18, wherein at least one of the fasteners comprises a rolling portion.

21. The system of claim 18, wherein at least one of the side rails comprises a section that is configured to laterally shift the position of a fastener engaging the shade as the fastener advances in a direction substantially along the length of the side rail and to thereby cause an increased tension across the shade such that the shade is kept taut across the width thereof.

22. The system of claim 21, wherein the section of at least one of the side rails that is configured to laterally shift the position of a fastener comprises an angled portion configured to produce the lateral shift of the fastener.

23. The system of claim 21, wherein the section of at least one of the side rails that is configured to laterally shift the position of a fastener comprises set screws configured to selectively increase or decrease lateral pull on the fastener.

24. The system of claim 18, wherein at least one of the side rails comprises a section configured to impose an increased closing force on a fastener as the fastener advances in a direction substantially along the length of the side rail, to thereby increase force of the engagement of the fastener on the shade.

25. The system of claim 24, wherein the section of at least one of the side rails that imposes the increased closing force comprises a portion configured to impose a vertical force on one or both of the top and bottom of the fastener to increase force of the engagement of the fastener on the shade.

26. The system of claim 24, wherein the section of at least one of the side rails that imposes the increased closing force comprises one or more set screws configured to selectively increase the force of the engagement of the fastener on the shade.

27. The system of claim 25, wherein the portion configured to impose the vertical force comprises an elevating section configured to increase the vertical elevation of the fastener from one or both of the top and bottom.

28. The system of claim 27, further comprising a top panel, the elevating section configured to increase the vertical elevation of the fastener and push the fastener against the top panel as the fastener advances in a direction substantially along the length of the side rail.

29. The system of claim 27, wherein the increasing vertical elevation causes the top and bottom of the fastener to squeeze to thereby increase the force of the engagement.

30. A method of manufacturing a retractable shade, comprising:
defining one or more pockets in a shade comprised of one or more sheets of a body of rollable material, the pockets configured to receive one or more springs for providing a retraction force to retract the shade from an unrolled state to a rolled-up state; and
disposing one or more magnetic elements between vacuum elements located on either side of one or more sheets, the one or more magnetic elements configured to hold the one or more sheets of material such as to prevent entry of air into the one or more pockets while the shade is being formed.

31. The method of claim 30, wherein the one or more magnetic elements are configured to hold down the one or more sheets during welding for defining the one or more pockets.

32. The method of claim 30, wherein the one or more magnetic elements comprise a magnetic strip disposed in a channel defined between the vacuum elements.

33. The method of claim 30, wherein the one or more magnetic elements comprise at least one magnet disposed between the vacuum elements and below the one or more sheets configured to, in combination with at least one other magnets disposed on top of the one or more sheets, create a magnetic force that holds the one more sheets and prevents the entry of air into the one or more pockets.

34. The method of claim 30, wherein the one or more magnetic elements comprise at least one magnet above or below the one or more sheets, and wherein the method further comprises disposing a metal element on a top or bottom side of the or more sheets that is opposite the at least one magnet.

35. The method of claim 30, wherein disposing the one or more magnetic elements between the vacuum elements comprises placing at least one magnetic element of the one or more magnetic elements on top of the one or more sheets of material and at least one other magnetic element of the one or more magnetic elements below the one or more sheets of material to generate a magnetic force pressing on the one or more sheets of material to prevent entry of air into the one or more pockets while the shade is being formed.
